(19) United States
(12) Patent Application Publication
(10) Pub. No.: US 2002/0175211 A1
(43) Pub. Date: Nov. 28, 2002

(54) Time and attendance system with verification of employee identity and geographical location

(76) Inventors: Francisco Dominquez, Chester, NJ (US); Luis R. Fernandez, Florham Park, NJ (US); Richard George Briggs, Long Valley, NJ (US); Michael Allen Tamayo, Kenilworth, NJ (US); John Lawrence Llewelyn, Dingmans Ferry, PA (US); Denis Peter Cainero, Westwood, NJ (US); Jose Matos, Bushkill, PA (US); Mario Mendoza, North Plainfield, NJ (US); Jorge L. Diaz, Orlando, FL (US); Armando J. Gonzalez, Neshanic Station, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/075,878

(22) Filed: Feb. 14, 2002

Related U.S. Application Data
(60) Provisional application No. 60/277,152, filed on Mar. 19, 2001.
(60) Provisional application No. 60/307,949, filed on Jul. 26, 2001.

(51) Int. Cl. G06K 19/06

(52) U.S. Cl. 235/492

(57) ABSTRACT

A time and attendance system and method are provided for monitoring employees at remote worksites such as construction sites. The system comprises one or more portable recording apparatuses. Each of these portable recording apparatuses includes means for identifying its geographical location, a keypad for the employees' entry of an ID upon clocking into or out of a worksite and a digital camera for capturing a visual image of the employees upon each such event. The recording apparatus captures and stores these data on a local database in association with the employees' IDs. The recording apparatus periodically establishes contact, over the Internet or another network, with a central computer to transmit the stored information, including the recording apparatus's geographical location, to the central computer. The central computer stores reference visual images for the employees. Using a computer connected to the network, an authorized user can access the central computer at any time to verify attendance at the worksite including comparing the visual images captured by the recording apparatus for the employees with their reference visual images.

### CROSS-REFERENCE TO RELATED APPLICATIONS

The present application claims the benefit of U.S. Provisional Patent Application No. 60/277,152 filed Mar. 19, 2001, and No. 60/301,949 filed Jul. 26, 2001, the entire disclosures of which are incorporated herein by reference.

### BACKGROUND OF THE INVENTION

The present invention relates to a system and method for recording and verifying information about employees and other individuals for accounting and payroll purposes. In particular, the present invention relates to a time and attendance system and method for clocking employees into and out of worksites at geographically remote locations and for verifying the employees' identity, hours worked and location of work at any selected time using a remote computer.

In the past, hourly employees have been charged with personal responsibility for recording their arrival and departure times at a worksite using a timesheet or time clock. More recently, computer-based timekeeping systems have been implemented. These computer-based timekeeping systems, however, are permanently installed at a worksite.

Also, most timekeeping systems rely on supervisory oversight to ensure the integrity of the timekeeping process. Problems arise, therefore, at worksites involving large numbers of employees arriving or departing a worksite at different times and at different points of entry and exit. Such problems are particularly acute in the construction industry where employees may be assigned to various worksites on different days. Fraudulent time entries in this industry frequently occur and are difficult to prevent.

Also, in these timesheet and time clock systems, an intermediary must transfer data recorded by the employees to other areas of the payroll system. These transfers are time consuming and increase the likelihood of errors in the data. Paper timesheets and punch cards can be lost, moreover, raising questions as to the actual number of hours worked.

Communications between management and employees also are a problem at widely dispersed and temporary worksites. The ideal time for such communications is when employees are arriving or departing the worksite. Supervisors must be present at the worksite's entrances, however, or notices must be posted.

Several attempts have been made in the prior art to improve time and attendance systems. U.S. Pat. No. 5,459,657 to Wynn et al. describes a computerized time and attendance system for enabling employees to clock into and clock out of locations near their workstations. The system includes time clocks connected to a central computer. The time clocks do not operate as autonomous units, however, and rely upon a continuous connection with the central computer. Clock-in or clock-out events, therefore, cannot be performed if the computer is down. Also, the time clocks are permanently installed at the workstations.

U.S. Pat. Nos. 5,550,359 and 5,642,160 to Bennett also describe a computerized time and attendance system. The system employs a plurality of reading devices connected to a central computer. The reading device scan and store a digital image of an employee's ID card (which may include a photograph) and the central computer periodically polls the reading devices to download the stored identification data. The reading devices, however, also are permanently installed at the worksite. Also, although U.S. Pat. No. 5,642,160 describes a separate video camera for capturing a visual image of the employee, the central computer does not maintain a database of reference visual images for comparison to this captured visual image.

A need exists, therefore, for a self-contained, portable time and attendance system which can be used at various geographically dispersed worksites, provides an efficient method for verifying the timekeeping process, facilitates the transfer of data and communications between management and employees and accurately reflects the hours of an employee's work.

### SUMMARY OF THE INVENTION

In one aspect, the present invention provides a self-contained, portable, time and attendance recording apparatus. The recording apparatus includes a processor with a data storage device and a data input device connected to the processor. The data input device enables entering of attendance data by a person indicating the person's identity and that he or she is clocking into or out of a worksite. The data input device also transmits the attendance data to the processor.

The recording apparatus also includes a clock connected to the processor for providing the time and date of the person's entering of the attendance data. The recording apparatus further includes a geographical locating device connected to the processor for providing to the processor the recording apparatus's geographical location. The processor stores the attendance data and the time and date in the storage device and associates the attendance data and the time and date with each other and with the geographical location as related data.

The recording apparatus also includes a data interface device for transmitting the related data through a communication network to a computer on the network. A power source also is included to provide power to the processor, the data storage device, the data input device, the clock, the geographical locating device and the data interface.

The recording apparatus preferably includes a biometric-capture device, connected to the processor, for capturing a biometric characteristic of the person. The processor preferably associates the biometric characteristic with the related data, and the data interface device preferably transmits the biometric characteristic with the related data through the communication network to the computer. The biometric-capture device preferably is a digital camera, and the biometric characteristic preferably is a visual image of the person.

The recording apparatus also preferably includes a display, connected to the processor, for displaying messages for the person and prompts for assisting the person in performing the entering of the attendance data. The display preferably is a liquid crystal display (LCD), and the data input device preferably is a touch-sensitive screen incorporated into the LCD.

The data interface preferably comprises a wireless modem, and the geographical locating device preferably comprises a global positioning (GPS) receiver. In the alternative, the geographical locating device may comprise a cellular transmitter/receiver. The power source preferably comprises a rechargeable battery.

The recording apparatus further preferably comprises a casing for housing the processor, the data storage device, the clock, the geographical locating device, the data interface and the power source. The casing preferably comprises a handle and a collapsible support affixed to a face of the casing for positioning the apparatus in an upright position on a flat surface. The display and keypad preferably from a face of the casing.

The recording apparatus also preferably is adapted for receiving from the computer through the network and the interface device messages for the person associated with the identification data. These messages are stored in the data storage device for later display to the person at the time of the person's entering of the attendance data.

In another aspect, the present invention provides a method for verifying time and attendance data entered by a person at a worksite. The method includes providing at a worksite a portable time and attendance recording apparatus. The recording apparatus includes a data storage device, a data input device, a clock, a geographical locating device and a data interface device. The method includes receiving on the recording apparatus attendance data entered by the person on the data input device indicating the identity of the person and that the person is clocking into or out of the worksite. The method further includes determining from the clock the time and date of the entering and from the geographical locating device the geographical location of the recording apparatus.

The method also includes storing the attendance data and the time and date in the storage device, and associating the attendance data and the time and date with each other and with the geographical location as related data. The method further includes transmitting the related data from the data interface device through a communication network to a first computer on the network remote from the geographical location.

The method preferably also includes obtaining access to the first computer from a second computer on the network for verifying the related data, including the geographical location, from the second computer.

The method also preferably includes providing on the recording apparatus a biometric-capture device for capturing a biometric characteristic of the person and storing a reference for the characteristic in a database associated with the first computer. The method also preferably comprises capturing on the biometric-capture device the person's biometric characteristic, storing the biometric characteristic in the storage device, associating the biometric characteristic with the related data, transmitting the biometric characteristic with the related data from the data interface device through the communication network to the first computer and later comparing from the second computer the biometric characteristic with the reference to verify the related data and the biometric characteristic.

The biometric-capture device preferably is a digital camera, the biometric characteristic preferably is a visual image of the person, and the reference for the characteristic preferably is a photograph of the person taken before the capturing.

The method also preferably comprises providing a display on the recording apparatus and displaying on the display messages for the person and prompts for assisting the person in performing the entering of the attendance data. The display preferably is an LCD, and the data input device preferably is a touch-sensitive screen incorporated into the LCD. The data interface device preferably includes a wireless modem, and the geographical locating device preferably is a global positioning system (GPS) receiver. In the alternative, the geographical locating device may comprise a cellular transmitter/receiver.

The method also preferably includes storing the messages in a database associated with the first computer, transmitting the messages from this database through the communication network for storage in the data storage device and retrieving the messages from the data storage device for displaying to the person.

The communication network preferably is the internet, the first computer preferably is an application service provider on the network and the second computer preferably is associated with a company employing the person. The comparing preferably comprises displaying on a display associated with the second computer the visual image of the person next to the person's photograph to enable an operator of the second computer to perform a visual comparison of the visual image and the photograph.

### BRIEF DESCRIPTION OF THE DRAWINGS

FIG. 1 is a schematic diagram of a time and attendance system in accordance with the present invention.

FIG. 2 is a schematic diagram of a recording apparatus in accordance with the present invention.

FIG. 3 is a depiction of the front panel of the recording apparatus of FIG. 2.

FIGS. 4A-4B are flow diagrams of a method of time and attendance in accordance with the present invention.

FIGS. 5A-5B are flow diagrams of a method for capturing and storing employee data in accordance with the present invention.

FIGS. 6A-6C depict an employee's use of a recording apparatus in accordance with the present invention.

FIG. 7 depicts the relationships among the data tables stored by the remote computer system depicted in FIG. 1.

FIG. 8 is a schematic diagram of an Internet-based time and attendance system in accordance with the present invention.

### DETAILED DESCRIPTION OF THE PREFERRED EMBODIMENTS

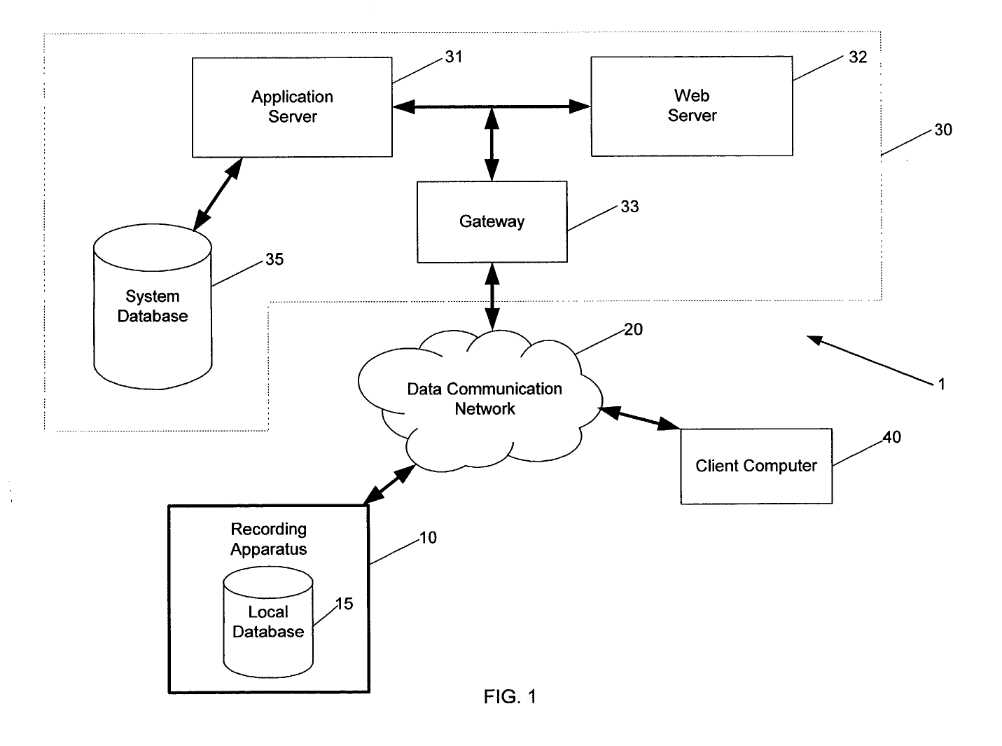

A preferred embodiment of a time and attendance system 1 in accordance with the present invention is shown in FIG. 1. System 1 comprises at least one recording apparatus 10, a data communication network 20, e.g., the Internet, a remote computer system 30 and client computer 40. Data communication network 20 provides communications among these components. Data communication network 20 may be a wide area network, such as the Internet, or a local area network (LAN) and may comprise both land-line and wireless telecommunication facilities.

Remote computer system 30 comprises at least one computer for receiving, storing and displaying data received from recording apparatus 10 and for sending data to recording apparatus 10. Remote computer system 30 also comprises a system relational database 35 containing data pertinent to the time, attendance and messaging functions of recording apparatus 10. Such data may include reference data identifying a particular company or client and the company's employees, supervisors, worksites, subcontractors and other such information. These data also may include information relating to a worksite of the company, or the employees at the worksite, transmitted from recording apparatus 10 to remote computer system 30.

Remote computer system 30 comprises an application server 31 for performing the calculations and control functions of system 1. Remote computer system 30 further comprises web server 32 for responding to data requests from client computer 40. These responses include providing web pages containing the requested data transmitted through data communication network 20. Remote computer system 30 also includes gateway server 33 for coordinating communications between remote computer system 30 and data communication network 20 and providing security for remote computer system 30. Remote computer system 30 may be distributed among a multiplicity of computers and be structured as an application service provider (ASP).

Recording apparatus 10 is a self-contained, portable, time and attendance recording device which serves as the employees' point for interaction with system 1. These interactions include clocking into a worksite, clocking out of a worksite, enrolling an employee of a client or company onto system 1 and acknowledging messages to an employee from a company or client of system 1. Recording apparatus 10 is adapted to prompt employees to perform various actions appropriate to these functions.

Recording apparatus 10 operates autonomously with only occasional interaction with remote computer system 30. Recording apparatus 10 contains a local relational database 15 comprising a subset of the data contained in system relational database 35. This subset is relevant to the employees assigned to the worksite and the company with which recording apparatus 10 is associated. Recording apparatus 10 periodically establishes contact with remote computer system 30 to transmit data collected and stored in local database 15 and to receive data from system database 35 for storage in local database 15. Remote computer system 30 also may initiate contact with recording apparatus 10 for these data exchanges.

Recording apparatus 10 also comprises a device for capturing a biometric characteristic of the employee. This biometric characteristic may be a visual image, voice pattern, iris pattern, fingerprint, etc. Because of the ease of visual comparison with a reference photograph and the wide availability of inexpensive digital cameras, however, a visual image of the employee is preferred. Commercial software also is available for extracting and comparing key features of such images where automatic comparison is preferred. Also, reliance on fingerprints, e.g., is a disadvantage at workplaces such as construction sites where fingerprints may be obscured by dirt, paint, etc.

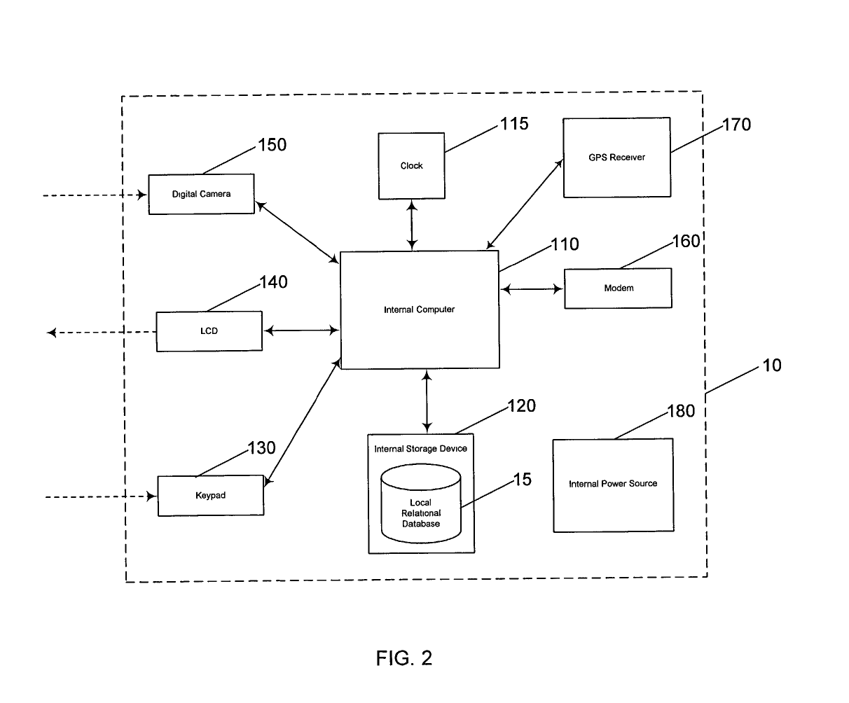

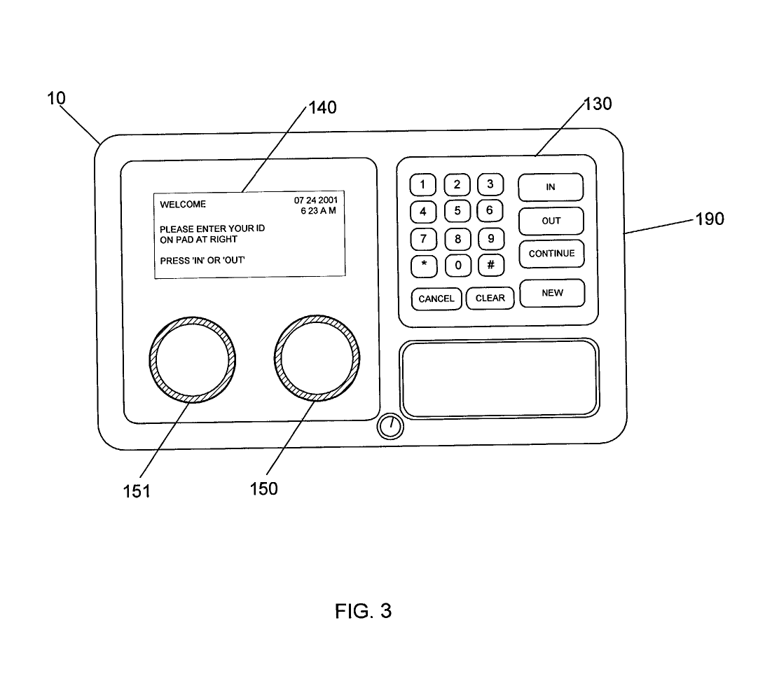

FIGS. 2 and 3 further illustrate the components and structure of recording apparatus 10. Internal computer 10 controls the various functions and components of recording apparatus 10 according to one or more resident application programs. Internal computer 1 comprises a processor, a random access memory (RAM), preferably providing a minimum of 32 megabytes of storage, and a miniaturized motherboard with an internal data bus operating at a minimum of 66 megahertz (Mhz). The resident application programs and local relational database 15 are stored in internal data storage device 120. Internal data storage device 120 preferably is a hard drive, adapted to withstand frequent handling and movement, and providing a minimum storage capacity of one gigabyte (GB) of data.

Recording apparatus 10 further comprises internal clock 115 for providing the current time and date to internal computer 110 in a digital format. In the alternative, an external clock connected to internal computer 110 may be employed. The current time and date are displayed on liquid crystal display (LCD) 140 and, as further explained below, are stored as digital time stamps contemporaneously with employee identification and clock-in/clock-out event data captured by recording apparatus 10.

Recording apparatus 10 further comprises keypad 130 and digital camera 150. Keypad 130 preferably is a flat panel sealed keypad with ten digit keys and ten or more additional programmable command keys for accommodating additional input codes. In the alternative, keypad 130 may be a touch-screen incorporated into LCD 140 or into a separate LCD. In lieu of keypad 130, any other computer input device may be employed, e.g., a mouse, a voice-recognition system, a card-reading device, a document scanner etc.

LCD 140 preferably is capable of displaying at least fifteen characters by thirty characters. In the alternative, LCD 140 may be a cathode ray tube (CRT) or any other display compatible with internal computer 110. Recording apparatus 10 also may include, in addition to LCD 140, a speaker for generating audible messages.

Recording apparatus 10 also includes modem 160 for providing communication between recording apparatus 10 and data communication network 20. Modem 160 preferably is a wireless modem and may comprise an Internet connection card, a wireless network interface card, a cellular transmitter/receiver or other device for providing wireless or cellular communication with data communication network 20. In the alternative, a land-line modem may be employed, e.g., a 56K V. 90modem with a standard land-line telephone jack.

Recording apparatus 10 further comprises digital camera 150 for capturing images and transmitting these images in a digital format to internal computer 110. Digital camera 150 preferably has an image-capture resolution of one megapixel, a LUX capacity of at least two and a wide-focus range down to a distance of six inches or less. Recording apparatus 10 also may include a second, backup camera 151 (FIG. 3) in the event of failure of camera 150. In the alternative or in addition, any other device for recording a biometric characteristic of a person may be employed or included, e.g., an iris scanner, a fingerprint scanner, a speech-pattern recognition device, a keystroke-pattern recognition device, etc.

Recording apparatus 10 further comprises global positioning system (GPS) receiver 170 for determining the geographical location of recording apparatus 10 and transmitting this location to internal computer 110. In the alternative or in addition, recording apparatus 10 may include any other device for determining its geographical location, e.g., a cellular transmitter/receiver receiving a signal identifying the location of the cellular transmitter/receiver from a cellular system adapted to provide such a function using triangulation of transmitted signals or similar methodologies.

Recording apparatus 10 also includes appropriate adapters and converters (not shown) for operating from either alternating current (AC) or direct current (DC) sources, e.g., an automobile's cigarette lighter. Recording apparatus 10 further includes an internal power supply 180, e.g., a rechargeable battery adequate to provide uninterrupted power for preferably eight hours or more.

Recording apparatus 10 is adapted to operate reliably in various outdoor environments and with frequent relocations. The recording apparatus's depth preferably is less than four inches, the longest dimension of its face preferably is less than twelve inches and its weight preferably is less than five pounds. The components of the recording apparatus are housed within protective enclosure 190 (FIG. 3). A collapsible support (not shown) may be affixed to the back of this enclosure for positioning recording apparatus 10 in an upright position on a table or other flat surface at a worksite and a handle (also not shown) also may be affixed to the enclosure to facilitate portability. The enclosure preferably meets or exceeds the requirements of the NEMA 4 standard and is tamperproof. Keypad 130, LCD 140 and digital camera 150 preferably are resistant to weather, rough use and debris such as mud, sand, dirt and other contaminants frequently found at outdoor worksites. Also, LCD 140 preferably is adapted for easy viewing in direct or indirect sunlight.

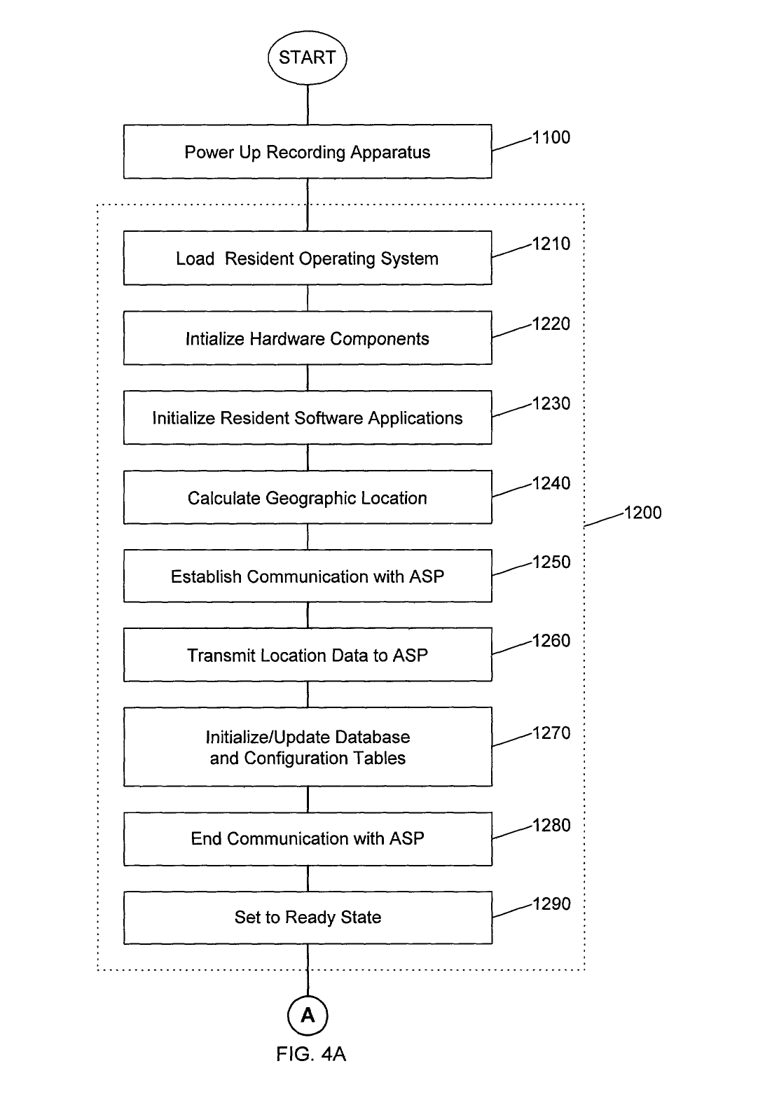

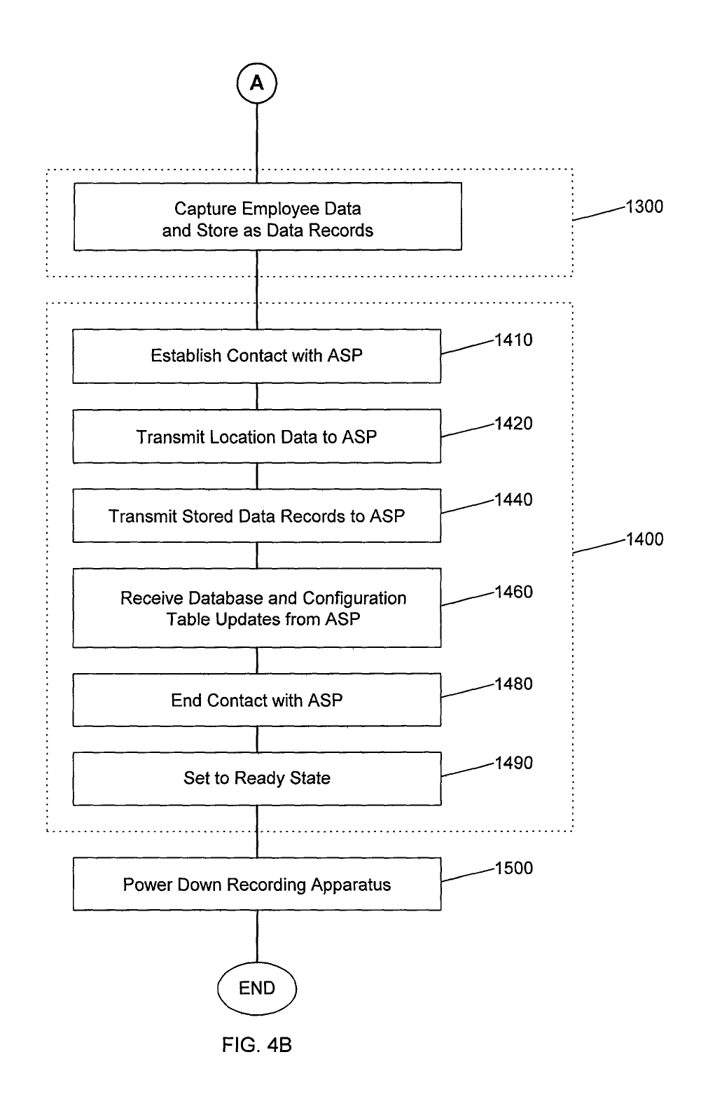

FIG. 4A illustrates the steps of startup and initialization of recording apparatus 10. Recording apparatus 10 powers up at step 1100 and executes an initialization procedure at step 1200. This initialization procedure includes the steps of loading the recording apparatus's resident operating system at step 1210, initializing its hardware components at step 1220, loading and running the apparatus's resident application software at step 1230, determining the apparatus's geographic location at step 1240, establishing communication with remote computer system 30 (preferably an ASP) at step 1250, transmitting a signal identifying the geographical location to the remote computer system at step 1260, downloading data (including configuration tables) from remote computer system 30 to initialize local database 15 at step 1270, ending communication with remote computer system 30 at step 1280 and setting recording apparatus 10 to a ready state for interacting with employees at step 1290.

FIG. 4B illustrates the steps of capturing time and attendance data at a worksite using recording apparatus 10 and transmitting these data over data communication network 20 to remote computer system 30. The capture of time and attendance data preferably is organized around two classes of events during an employee's workday, namely, “clock-in” events and “clock-out” events. A clock-in event is an event where an employee reports to the worksite and his or her time of arrival is recorded. A clock-out event is an event where an employee leaves the worksite and his or her time of departure is recorded. Events in which an employee leaves the worksite during the middle of a shift and returns to restart the shift (e.g., a lunch break) are treated as special cases of the clock-out and clock-in events. Recording apparatus 10 also performs “enrollment events.” An enrollment event is an event at which an employee's identification data are entered into local database 15 for the first time for subsequent transfer to system database 35 of remote computer system 30. An enrollment event also is treated as a special case of a clock-in event.

As shown in FIG. 4B, at step 1300, recording apparatus 10 captures and stores a data record upon each occurrence of a clock-in or a clock-out event. The repeating of step 1300 is limited by a programmed maximum number of events or the storage capacity of internal storage device 120. Steps 1400 are executed periodically after a number of occurrences of step 1300. Steps 1400 comprise periodically establishing communications between recording apparatus 10 and remote computer system 30 for transmitting data collected during clock-in and clock-out events to system database 35 and receiving data from the system database for storage in local database 15.

With respect to steps 1400, contact between recording apparatus 10 and remote computer system 30 is established at step 1410. Recording apparatus 10 then transmits to remote computer system 30, at step 1420, data identifying its geographical location. At step 1440, recording apparatus 10 transmits stored data records from local database 15 to remote computer system 30. At step 1460, remote computer system 30 transmits updated data and tables to local database 15. Communications between recording apparatus 10 and remote computer system 30 than are terminated at step 1480, and recording apparatus 10 returns to a ready state at step 1490 to continue recording and capturing clock-in and clock-out events. At step 1500, during periods in which no such events are occurring, recording apparatus 10 is powered down.

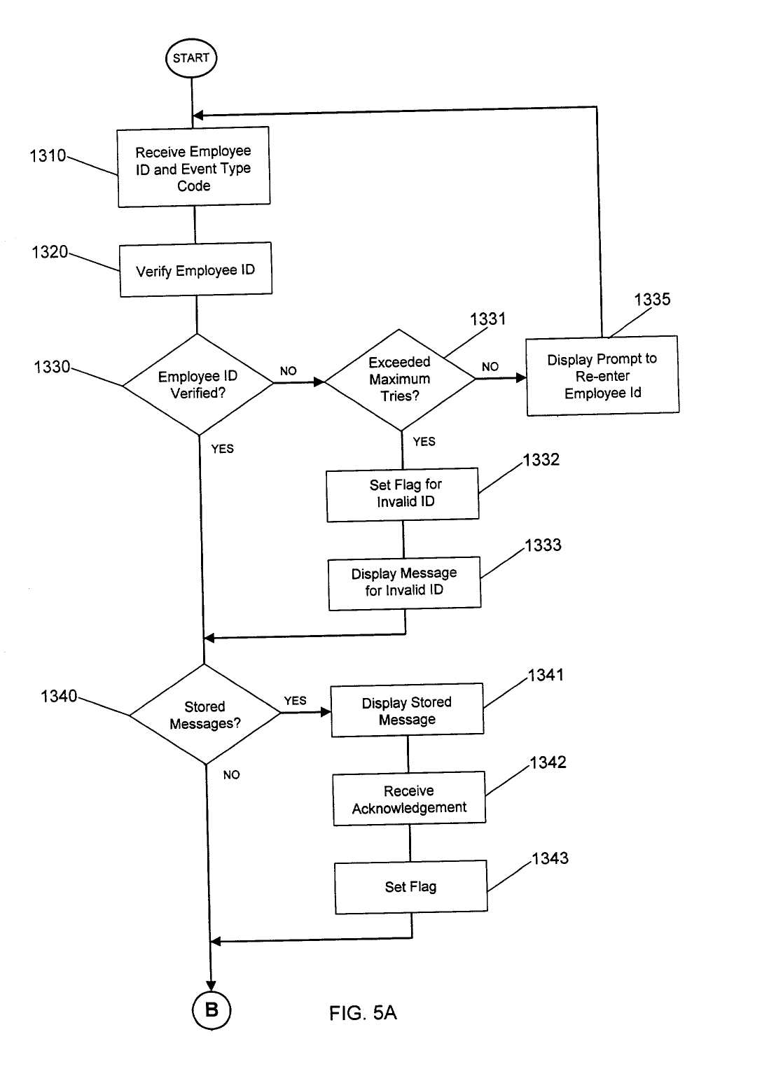

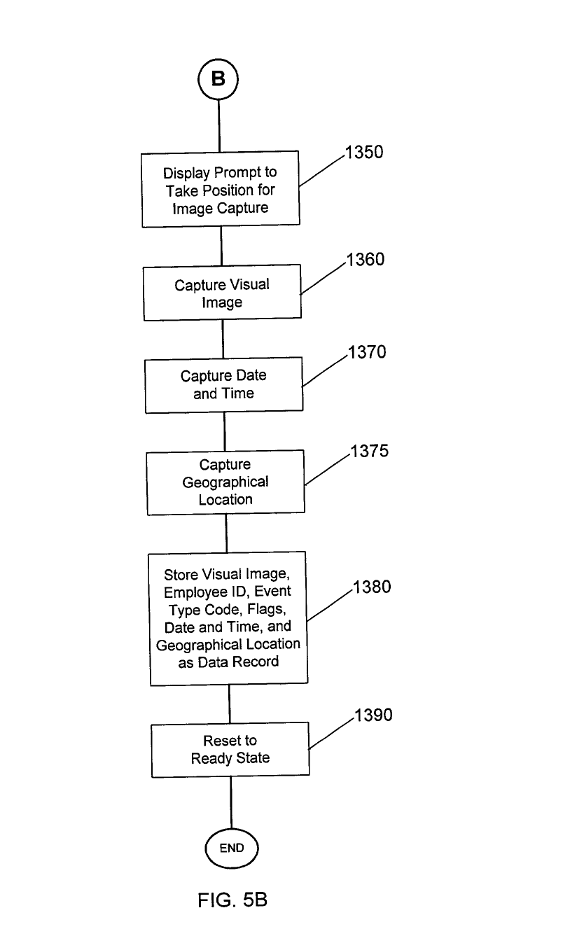

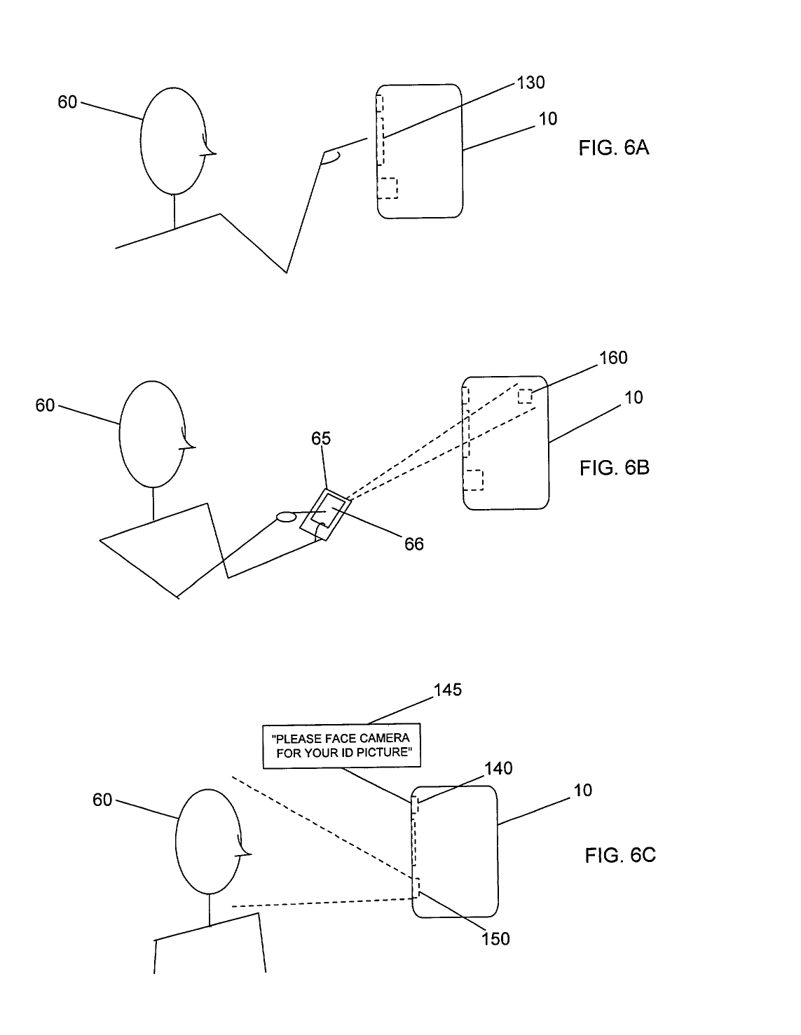

FIGS. 5A, 5B, 6A, 6B and 6C further illustrate the steps associated with clock-in and clock-out events. These steps include capturing employee identification data, e.g., an identification code and a biometric characteristic of the employee (preferably a visual image), the time and date of the clock-in or clock-out event and information identifying the geographical location of recording apparatus 10 at the time of the event. In the alternative or in addition, the information identifying the geographical location of recording apparatus 10 may be captured at the time of startup and initialization of recording apparatus 10 and at the time of communication between recording apparatus 10 and remote computer system 30.

Referring to FIGS. 5A and 6A, employee 60, using keypad 130, enters at step 1310 an employee identification code (employee ID) and an event code identifying the type of event (i.e., shift clock-in, shift clock-out, lunch clock-in, lunch clock-out, enrollment, etc.). The programmable command keys of keypad 130 are programmed to display indicia identifying the available types of events. In the alternative, as shown in FIG. 6B, employee 60 may transmit to recording apparatus 10, or directly to remote computer system 30, his or her employee ID, event code and other input-data using wireless electronic communication device 65. This device may be, e.g., a cellular telephone, personal digital assistant (PDA), an infrared transmitter or other wireless electronic communication device having a means 66, such as a keypad or touch screen, by which employee 60 may enter data and a means, such as an LCD, by which employee 60 may receive and review data. Data may be transmitted between electronic communication device 65 and recording apparatus 10 by modem 160 built into recording apparatus 10.

Referring again to FIG. 5A, following entry of the employee ID and event code at step 1310, recording apparatus 10 initiates, at step 1320, verification of the employee ID. Internal computer 110 searches an appropriate table in local database 15 to find a stored employee ID matching the entered employee ID. At step 1330, internal computer 110 determines whether the entered employee ID matches a stored employee ID. If a match occurs, the process advances to step 1340. If a match does not occur, then, at step 1331, internal computer 110 determines whether the employee has exceeded a predetermined number of attempts to enter a matching employee ID. If this number has not been exceeded, then, at step 1335, a prompt is displayed on LCD 140 instructing the employee to re-enter the ID. Each attempt to enter an ID is recorded with the date and time of its occurrence. The process then returns to step 1310.

On the other hand, if at step 1331, the employee has exceeded the predetermined number of attempts to enter a matching employee ID, then, at step 1332, internal computer 110 sets a flag for an invalid ID at step 1332. At step 1333, a message is displayed on LCD 140 stating that the entered ID is invalid and that corrective action should be taken through the employee's supervisor. The process then advances to step 1340.

At step 1340, internal computer 110 searches local database 15 for any messages for the employee associated with the verified employee ID or indicia entered by an employee in lieu of a verified employee ID. Any such messages are retrieved from the local database and displayed on LCD 140 at step 1341. Such messages may include, for example, a reassignment of worksites, a request to report to a supervisor or a warning that the employee has been excessively tardy. At step 1342, the employee enters a code acknowledging the message's display and receipt, and recording apparatus 10 records the acknowledgement at step 1343.

Referring to FIGS. 5B and 6C, recording apparatus 10 then, at step 1350, displays prompt 145 on LCD 130 instructing employee 60 to position himself or herself in front of built-in digital camera 150 for capturing his or her visual image. Recording apparatus 10 captures the visual image at step 1360 and, at step 1370, records the time and date of this capturing. In the alternative, recording apparatus 10 may capture the employee's visual image at step 1310 in response to entry of his or her ID and the event code. Recording apparatus 10 next, at step 1375, records the geographical location of the recording apparatus at the time that the visual image is captured. At step 1380, recording apparatus 10 stores a digital representation of the visual image and the geographical location in local database 15. This image and location are associated with the employee ID, the event code and the time and date of the event as a data record. Recording apparatus 10 then, at step 1390, resets to a ready state to receive the next employee ID and event code.

The clock-out procedure is substantially the same as the clock-in procedure. Upon clocking out for the day, however, recording apparatus 10 calculates the time elapsed between the clock-in event and the clock-out event and displays the total time on LCD 140. Recording apparatus 10 also preferably displays the employee's total hours worked for the week and breaks these hours down on a daily basis and into regular hours and overtime hours.

The data elements of a record preferably are small for efficient transmission from recording apparatus 10 to remote computer system 30. Table 1 identifies the data elements that may be associated with a visual image and stored for an event as a record in local database 15 for later transmission to remote computer system 30 with the visual image.

TABLE 1
ELEMENTS OF EVENT RECORD

| No. | ELEMENT |
|---|---|
| 1 | Unit ID |
| 2 | Site ID |
| 3 | Company ID |
| 4 | Employee ID |
| 5 | Event Type |
| 6 | Missed Event Flag |
| 7 | Late Clock-In Flag |
| 8 | Overtime Flag |
| 9 | Invalid Log-In Flag |
| 10 | New Employee Flag |
| 11 | Time/Date Stamp |
| 12 | Geographical Location Stamp |
| 13 | Dynamic Address Link To Visual |
| | Image |
| 14 | Size Of Visual Image (kbytes) |

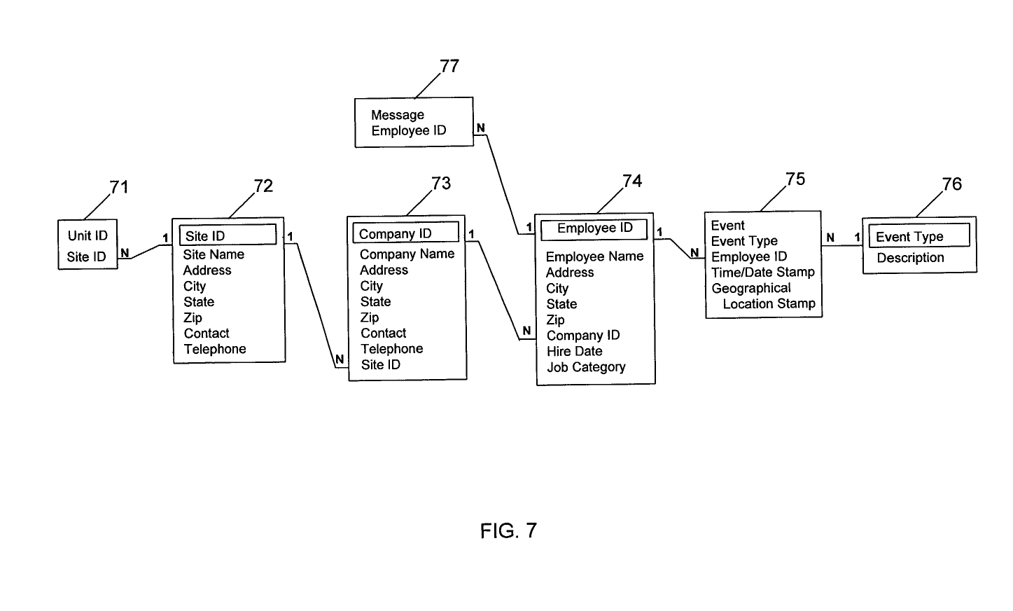

Data transfers between local database 15 and system database 35 are implemented using one or more subsets of the data tables in system database 35. A preferred structure for these data tables is depicted in FIG. 7. These tables include recording unit table 71, site table 72, company table 73, employee table 74, event table 75, event-type table 76 and message table 77. FIG. 7 also depicts the logical relationships linking particular data elements (1) of a record in a data table to a plurality of records (N) in another data table.

Recording unit table 71 contains records identifying a particular recording apparatus 10. A worksite may include a plurality of recording apparatuses, e.g., a recording apparatus located at each entrance to the worksite. Each record in table 71 includes a recording unit ID and a site ID.

Site table 72 contains records identifying a particular worksite. These records include the worksite's ID, the worksite's name and address and the telephone number of the contact person for the worksite. The worksite ID in a record links the record to a plurality of records in recording unit table 71 and also to a plurality of records in company table 73.

Company table 73 contains records identifying a company to which one or more employees at the worksite is assigned. These records include the company's ID, the company's name and address and a telephone number of a contact person for the company. The company ID in a record links the record to a plurality of records in employee table 74.

Employee table 74 contains records identifying a particular employee assigned to the worksite. These records include the employee's ID, name, address, company ID, hire date and job category. The employee ID in a record links the record to a plurality of records in event table 75 and also to a plurality of records in message table 77.

Event table 75 contains records identifying recorded events. These records include the event's type, the ID of the employee initiating the event, a time/date stamp for the event and a geographical location stamp for the event.

Event-type table 76 contains records on the types of events recorded. These records include the event type, e.g., clock-in, clock-out, lunch clock-in, lunch clock-out, enrollment, etc., and a description of the event. The event type in a record links the record to a plurality of records in event table 75. The records in event-type table 76 provide data for generating daily and weekly time reports and to evaluate these reports against data identifying an employee's schedule.

Message table 77 contains records providing messages for particular employees transmitted from system database 35 to local database 15. These records include the ID of the employee to whom the message is directed. A message preferably is in the form of text for display on LCD 140 but, in the alternative, may be in the form of a sound recording, a video recording or some other format reproducible by recording apparatus 10. Any number of messages may be associated with a particular employee ID or any number of employee IDs. Also, messages may be designated for a category of employees, or all employees, associated with a particular company or the worksite.

System database 35 may include additional tables for performing higher-level functions such as payroll accounting, employee scheduling, etc. For example, system database 35 may include a personnel table comprising data on a particular company and its personnel for payroll accounting. The data in such a table may include the IDs of verified employees, time-in and time-out records, indexes to messages and acknowledgement flags for particular events. System database 35 also may include an employee scheduling table containing, e.g., data regarding each employee's weekly work schedule, history of tardiness, allowable work hours, hours worked, overtime and other data relevant to a particular employee and his or her work schedule. Remote computer system 30 preferably generates such tables automatically for analyzing the availability and performance of personnel and providing assistance in job scheduling. Also, configuration tables providing selected operating parameters for particular tables for recording apparatus 10 may be transmitted from remote computer system 10 for storage in local database 15.

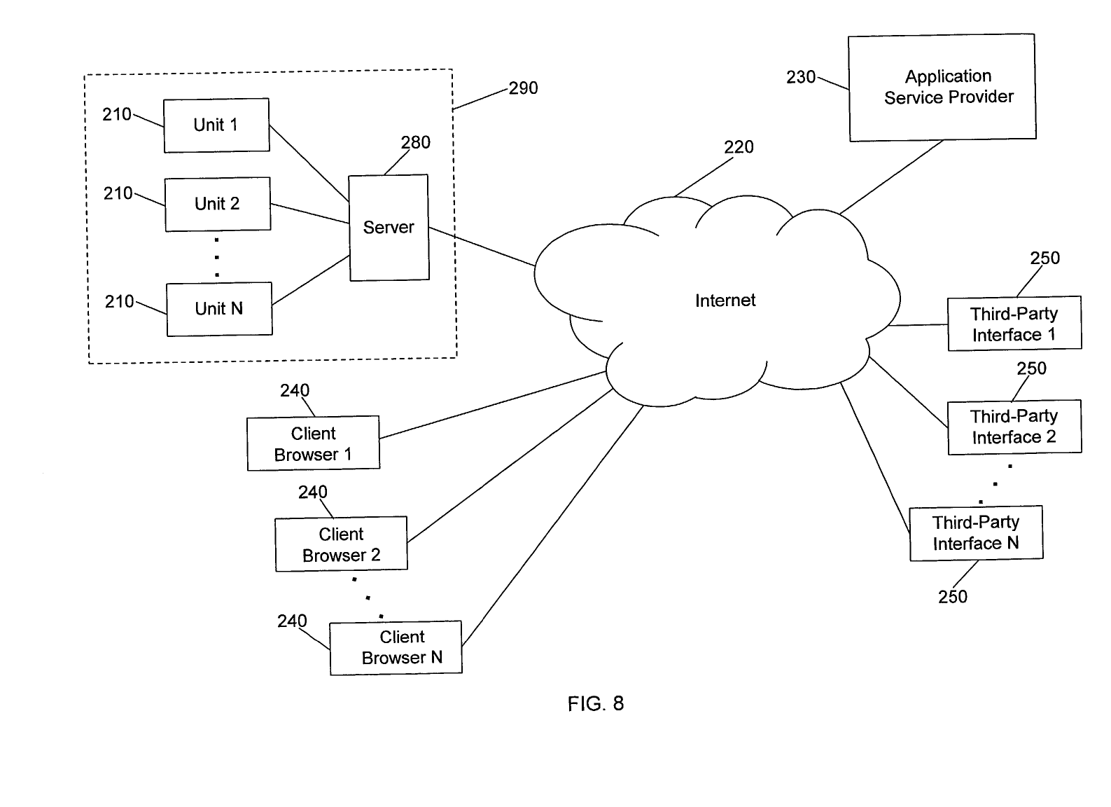

FIG. 8 further illustrates the use and operation of remote computer system 30 when structured as an application service provider (ASP) connected to the Internet. As shown in this figure, ASP 230 is connected, through Internet 220, to centralized server computer 280, client computers 240 and third-party interfaces 250. Client computers 240 include web browser software and other application programs. Server computer 280 is connected, through a wireless or wired wide area network (WAN) or a local area network (LAN), to a plurality of recording apparatuses 210 at a worksite. Server computer 280 facilitates communications among ASP 230 and recording apparatuses 210 and provides security for these recording apparatuses from unauthorized entries by, for example, other computers connected to Internet 220. Third-party interfaces 250 provide interfaces to the computer systems of other companies which receive data from ASP 230 for further processing or transmit data to ASP 230 for the ASP's use or processing.

In operation, ASP 230 stores time and attendance data for access by a plurality of companies using client computers 240. Authorized users are associated with a company or client through an ID. Upon accessing ASP 230, a log-in page is displayed to the user for entering his or her ID. Upon validation of the ID, a home page associated with the user's company or client is displayed. ASP 230 also associates each ID with various authorization levels. Depending upon the user's authorization level, he or she then can access and modify various subsets of the data types identified in Table 1 associated with his or her company.

ASP 230 displays to a user on his or her client computer 240 records of events in the form of lists. Each event comprises a row of a list, and the various data-items corresponding to each event fall into columns along these rows. A row may be selected for more detailed display by clicking on a designated area of the row. A structure for the listing of an event in a row is shown in Table 2.

TABLE 2
ELEMENTS OF AN EVENT LISTING

| COLUMN | ITEM | DISPLAY |
|---|---|---|
| 0 | Select Row For Display | |
| 1 | Missed Event | Flag |
| 2 | Tardy Clock-In | Flag |
| 3 | Overtime | Flag |
| 4 | Invalid Log-In | Flag |
| 5 | New Employee | Flag |
| 6 | Event Thumbnail | Event Details |
| 7 | Hire Date/Baseline | Event Details |
| | Thumbnail | |
| 8 | Location/Site Name | Event Details |
| 9 | Event Date/Time | Event Details |
| 10 | Employee Name | Event Details |
| 11 | Event Type | Event Details |

Upon selecting a valid event, i.e., an event for which the ID of the employee initiating the event was validated by a recording apparatus 210, ASP 230 displays to the user on his or her client computer 240, in addition to more detailed information regarding the event, the visual image captured by recording apparatus 210 for the event. ASP 230 also displays to the user, next to this visual image, a reference visual image previously stored by ASP 230 associated with the ID of the employee initiating the event. As a result, the user is easily able to compare the two visual images and verify the employee's identity. An authorized user, therefore, can access ASP 230 at any convenient time from his or her client computer to conduct a comprehensive verification of the identity of the company's employees initiating events or to conduct a selected verification restricted to, e.g., particular employees or worksites.

An authorized user also may select for review an invalid event. ASP 230 displays to the user for such an event information similar to that for a valid event. This information includes the employee's visual image captured by recording apparatus 210 during the event. For an invalid event, however, no previously stored visual image is displayed. Also, the visual presentation of all information relating to invalid events preferably is distinct from that for valid events and includes a selectable option for the user to associate the event to a particular employee or a new employee.

The user also may transmit from a client computer 240 to ASP 230 a message for a particular employee indexed against the employee's ID or for a particular recording apparatus indexed against the recording apparatus's ID. ASP 230 transmits the message to the designated employee or recording apparatus. Using a client computer 240, a user also may modify the database or application programs maintained by ASP 230 for the user's company.

Of course, all of the steps described above in connection with FIG. 8 can be conducted by a client computer or workstation connected directly to remote computer system 30, i.e., a client computer or workstation not communicating through the Internet or another data communication network and without structuring remote computer system 30 as an ASP.

Although the invention herein has been described with reference to particular embodiments, these embodiments are merely illustrative of the principles and applications of the present invention. Numerous modifications may be made to these embodiments, and other arrangements may be devised without departing from the spirit and scope of the invention as defined by the appended claims.

1. A self-contained, portable time and attendance recording apparatus, comprising:
a processor;
a data storage device connected to said processor;
a data input device connected to said processor, said data input device being adapted for entering attendance data by a person indicating the identity of said person and that said person is clocking into or out of a worksite, said data input device being further adapted for transmitting said attendance data to said processor;
a clock connected to said processor, said clock being adapted for providing the time and date of said entering to said processor;
a geographical locating device connected to said processor, said geographical locating device being adapted for providing the geographical location of said apparatus to said processor, said processor being adapted to store said attendance data and said time and date in said storage device and to associate said attendance data and said time and date with each other and with said geographical location as related data;
a data interface device adapted for transmitting said related data through a communication network to a computer on said network; and
a power source adapted to provide power to said processor, said data storage device, said data input device, said clock, said geographical locating device and said data interface.

2. An apparatus as in claim 1, further comprising a biometric-capture device connected to said processor, said biometric-capture device being adapted for capturing a biometric characteristic of said person, said processor being further adapted for associating said biometric characteristic with said related data and said data interface device being further adapted for transmitting said biometric characteristic with said related data through said communication network to said computer.

3. An apparatus as in claim 2, wherein said biometric-capture device comprises a digital camera and said biometric characteristic is a visual image of said person.

4. An apparatus as in claim 1, wherein said data storage device is adapted for storing indicia identifying said worksite and a company employing said person, said processor is adapted for associating said indicia with said related data and said data interface device is adapted for transmitting said indicia with said related data through said communication network to said computer.

5. An apparatus as in claim 1, wherein said processor is further adapted for initiating said transmitting of said related data upon the storage capacity of said data storage device being reached.

6. An apparatus as in claim 1, wherein said processor is further adapted for initiating said transmitting of said related data upon request of said computer.

7. An apparatus as in claim 1, further comprising a display connected to said processor, said display being adapted for displaying messages for said person and prompts for assisting said person in performing said entering.

8. An apparatus as in claim 7, wherein said display comprises an LCD.

9. An apparatus as in claim 1, wherein said data input device comprises a keypad.

10. An apparatus as in claim 8, wherein said data input device comprises a touch-sensitive screen incorporated into said LCD.

11. An apparatus as in claim 1, wherein said data input device comprises a wireless electronic communication device.

12. An apparatus as in claim 1, wherein said data interface device comprises a wireless modem.

13. An apparatus as in claim 1, wherein said geographical locating device comprises a global positioning system (GPS) receiver.

14. An apparatus as in claim 1, wherein said geographical locating device comprises a cellular transmitter/receiver.

15. An apparatus as in claim 1, wherein said power source comprises a rechargeable battery.

16. An apparatus as in claim 1, further comprising a casing for housing said processor, said data storage device, said clock, said geographical locating device, said data interface device and said power source.

17. An apparatus as in claim 16, wherein said casing comprises a handle and a collapsible support affixed to a face of said casing for positioning said apparatus in an upright position on a flat surface.

18. An apparatus as in claim 16, further comprising a display connected to said processor, said display being adapted for displaying messages to said person and prompts for assisting said person in performing said entering and wherein said display forms a face of said casing.

19. An apparatus as in claim 18, wherein said data input device comprises a keypad and said keypad forms a face of said casing.

20. An apparatus as in claim 1, wherein said data interface device is further adapted for receiving from said computer for storage in said data storage device messages for said person associated with said identity.

21. An apparatus as in claim 20, further comprising a display connected to said processor and wherein said messages are displayed on said display.

22. A self-contained, portable time and attendance recording apparatus, comprising:
a processor;
a data storage device connected to said processor;
a data input device connected to said processor, said data input device being adapted for entering attendance data by a person indicating the identity of said person and that said person is clocking into or out of a worksite, said data input device being further adapted for transmitting said attendance data to said processor;
a clock connected to said processor, said clock being adapted for providing the time and date of said entering to said processor;
a biometric-capture device connected to said processor, said biometric-capture device being adapted for capturing a biometric characteristic of said person, said processor being adapted to associate said attendance data, said time and date and said biometric characteristic with each other as related data and to store said related data in said storage device;
a data interface device adapted for transmitting said related data through a communication network to a computer on said network; and
a power source adapted to provide power to said processor, said data storage device, said data input device, said clock, said biometric-capture device and said data interface.

23. An apparatus as in claim 22, further comprising a geographical locating device connected to said processor, said geographical locating device being adapted for providing the geographical location of said apparatus to said processor, said processor being further adapted for associating said geographical location with said related data and said data interface device being further adapted for transmitting said geographical location with said related data through said communication network to said computer.

24. An apparatus as in claim 22, wherein said biometric-capture device comprises a digital camera and said biometric characteristic is a visual image of said person.

25. An apparatus as in claim 22, wherein said data storage device is adapted for storing indicia identifying said worksite and a company employing said person, said processor is adapted for associating said indicia with said related data and said data interface device is adapted for transmitting said indicia with said related data through said communication network to said computer.

26. An apparatus as in claim 22, wherein said processor is further adapted for initiating said transmitting of said related data upon the storage capacity of said data storage device being reached.

27. An apparatus as in claim 22, wherein said processor is further adapted for initiating said transmitting of said related data upon request of said computer.

28. An apparatus as in claim 22, further comprising a display connected to said processor, said display being adapted for displaying messages for said person and prompts for assisting said person in performing said entering.

29. An apparatus as in claim 28, wherein said display comprises an LCD.

30. An apparatus as in claim 22, wherein said data input device comprises a keypad.

31. An apparatus as in claim 29, wherein said data input device comprises a touch-sensitive screen incorporated into said LCD.

32. An apparatus as in claim 22, wherein said data input device comprises a wireless electronic communication device.

33. An apparatus as in claim 22, wherein said data interface device comprises a wireless modem.

34. An apparatus as in claim 23, wherein said geographical locating device comprises a global positioning system (GPS) receiver.

35. An apparatus as in claim 23, wherein said geographical locating device comprises a cellular transmitter/receiver.

36. An apparatus as in claim 22, wherein said power source comprises a rechargeable battery.

37. An apparatus as in claim 22, further comprising a casing for housing said processor, said data storage device, said clock, said biometric-capture device, said data interface device and said power source.

38. An apparatus as in claim 37, wherein said casing comprises a handle and a collapsible support affixed to a face of said casing for positioning said apparatus in an upright position on a flat surface.

39. An apparatus as in claim 37, further comprising a display connected to said processor, said display being adapted for displaying messages to said person and prompts for assisting said person in performing said entering and wherein said display forms a face of said casing.

40. An apparatus as in claim 39, wherein said data input device comprises a keypad and said keypad forms a face of said casing.

41. An apparatus as in claim 22, wherein said data interface device is further adapted for receiving from said computer for storage in said data storage device messages for said person associated with said identity.

42. An apparatus as in claim 41, further comprising a display connected to said processor and wherein said messages are displayed on said display.

43. A self-contained, portable time and attendance recording apparatus, comprising:
a processor;
a data storage device connected to said processor;
a data input device connected to said processor, said data input device being adapted for entering attendance data by a person indicating the identity of said person and that said person is clocking into or out of a worksite, said data input device being further adapted for transmitting said attendance data to said processor;
a clock connected to said processor, said clock being adapted for providing the time and date of said entering to said processor;
a biometric-capture device connected to said processor, said biometric-capture device being adapted for capturing a biometric characteristic of said person and providing said characteristic to said processor;
a geographical locating device connected to said processor, said geographical locating device being adapted for providing the geographical location of said apparatus to said processor, said processor being adapted to store said attendance data, said time and date and said biometric characteristic in said storage device and to associate said attendance data, said time and date, said biometric characteristic and said geographical location with each other as related data;
a data interface device adapted for transmitting said related data through a communication network to a computer on said network; and
a power source adapted to provide power to said processor, said data storage device, said data input device, said clock, said biometric-capture device, said geographical locating device and said data interface.

44. An apparatus as in claim 43, wherein said biometric-capture device comprises a digital camera and said biometric characteristic is a visual image of said person.

45. An apparatus as in claim 43, wherein said data storage device is adapted for storing indicia identifying said worksite and a company employing said person, said processor is adapted for associating said indicia with said related data and said data interface device is adapted for transmitting said indicia with said related data through said communication network to said computer.

46. An apparatus as in claim 43, wherein said processor is further adapted for initiating said transmitting of said related data upon the storage capacity of said data storage device being reached.

47. An apparatus as in claim 43, wherein said processor is further adapted for initiating said transmitting of said related data upon request of said computer.

48. An apparatus as in claim 43, further comprising a display connected to said processor, said display being adapted for displaying messages for said person and prompts for assisting said person in performing said entering.

49. An apparatus as in claim 48, wherein said display comprises an LCD.

50. An apparatus as in claim 43, wherein said data input device comprises a keypad.

51. An apparatus as in claim 49, wherein said data input device comprises a touch-sensitive screen incorporated into said LCD.

52. An apparatus as in claim 43, wherein said data input device comprises a wireless electronic communication device.

53. An apparatus as in claim 43, wherein said data interface device comprises a wireless modem.

54. An apparatus as in claim 43, wherein said geographical locating device comprises a global positioning system (GPS) receiver.

55. An apparatus as in claim 43, wherein said geographical locating device comprises a cellular transmitter/receiver.

56. An apparatus as in claim 43, wherein said power source comprises a rechargeable battery.

57. An apparatus as in claim 43, further comprising a casing for housing said processor, said data storage device, said clock, said biometric-capture device, said geographical locating device, said data interface device and said power source.

58. An apparatus as in claim 57, wherein said casing comprises a handle and a collapsible support affixed to a face of said casing for positioning said apparatus in an upright position on a flat surface.

59. An apparatus as in claim 57, further comprising a display connected to said processor, said display being adapted for displaying messages to said person and prompts for assisting said person in performing said entering and wherein said display forms a face of said casing.

60. An apparatus as in claim 59, wherein said data input device comprises a keypad and said keypad forms a face of said casing.

61. An apparatus as in claim 43, wherein said data interface device is further adapted for receiving from said computer for storage in said data storage device messages for said person associated with said identity.

62. An apparatus as in claim 61, further comprising a display connected to said processor and wherein said messages are displayed on said display.

63. A method for recording and verifying time and attendance data entered by employees at a worksite, comprising
providing at a worksite a portable time and attendance recording apparatus, said recording apparatus comprising a data storage device, a data input device, a clock, a geographical locating device and a data interface device;
receiving on said recording apparatus attendance data entered by a person on said data input device indicating the identity of said person and that said person is clocking into or out of said worksite;
determining from said clock the time and date of said entering;
determining from said geographical locating device the geographical location of said recording apparatus;
storing said attendance data and said time and date in said storage device;
associating said attendance data and said time and date with each other and with said geographical location as related data;
transmitting said related data from said data interface device through a communication network to a first computer on said network remote from said geographical location.

64. A method as in claim 63, further comprising obtaining access to said first computer from a second computer on said network and verifying said related data, including said geographical location, from said second computer.

65. A method as in claim 64, wherein said recording apparatus further comprises a biometric-capture device for capturing a biometric characteristic of said person and said first computer contains a database storing a reference for said biometric characteristic, and further comprising capturing on said biometric-capture device said biometric characteristic, storing said biometric characteristic in said storage device, associating said biometric characteristic with said related data, transmitting said biometric characteristic with said related data from said data interface device through said communication network to said first computer and comparing from said second computer said biometric characteristic with said reference to verify said biometric characteristic.

66. A method as in claim 65, wherein said biometric-capture device comprises a digital camera, said biometric characteristic is a visual image of said person and said reference for said characteristic is a photograph of said person taken prior to said capturing.

67. A method as in claim 63, further comprising storing indicia identifying said worksite and a company employing said person in said data storage device, associating said indicia with said related data and transmitting said indicia with said related data from said data interface device through said communication network to said first computer.

68. A method as in claim 63, further comprising initiating said transmitting of said related data upon the storage capacity of said data storage device being reached.

69. A method as in claim 63, further comprising initiating said transmitting of said related data upon request of said computer.

70. A method as in claim 63, wherein said recording apparatus further comprises a display, and further comprising displaying on said display messages for said person and prompts for assisting said person in performing said entering.

71. A method as in claim 70, wherein said display comprises an LCD.

72. A method as in claim 63, wherein said data input device comprises a keypad.

73. A method as in claim 71, wherein said data input device comprises a touch-sensitive screen incorporated into said LCD.

74. A method as in claim 63, wherein said data input device comprises a wireless electronic communication device.

75. A method as in claim 63, wherein said data interface device comprises a wireless modem.

76. A method as in claim 63, wherein said geographical locating device comprises a global positioning system (GPS) receiver.

77. A method as in claim 63, wherein said geographical locating device comprises a cellular transmitter/receiver.

78. A method as in claim 70, wherein said first computer comprises a database and further comprising storing said messages in said database associated with said identity, transmitting said messages from said database through said communication network for storage in said data storage device and retrieving said messages from said data storage device for said displaying.

79. A method as in claim 64, wherein said communication network comprises the Internet, said first computer is associated with an application service provider on said Internet and said second computer is associated with a company employing said person.

80. A method as in claim 66, wherein said comparing comprises displaying on a display associated with said second computer said visual image next to said photograph to enable an operator of said second computer to perform a visual comparison of said visual image and said photograph.

81. A method for recording and verifying time and attendance data entered by employees at a worksite, comprising
providing at a worksite a portable time and attendance recording apparatus, said recording apparatus comprising a data storage device, a data input device, a clock, a biometric-capture device and a data interface device;
receiving on said recording apparatus attendance data entered by a person on said data input device indicating the identity of said person and that said person is clocking into or out of said worksite;
determining from said clock the time and date of said entering;
capturing from said biometric-capture device a biometric characteristic of said person;
storing said attendance data, said time and date and said biometric characteristic in said storage device;
associating said attendance data, said time and date and said biometric characteristic with each other as related data;
transmitting said related data from said data interface device through a communication network to a first computer on said network remote from said worksite.

82. A method as in claim 81, further comprising obtaining access to said first computer from a second computer on said network and verifying said related data, including said biometric characteristic, from said second computer.

83. A method as in claim 82, wherein said recording apparatus further comprises a geographical locating device, and further comprising determining from said geographical locating device the geographical location of said recording apparatus, associating said geographical location with said related data, transmitting said geographical location with said related data from said data interface device through said communication network to said first computer and verifying from said second computer said geographical location.

84. A method as in claim 82, wherein said first computer contains a database storing a reference for said biometric characteristic and said verifying comprises comparing from said second computer said biometric characteristic with said reference.

85. A method as in claim 84, wherein biometric-capture device comprises a digital camera, said biometric characteristic is a visual image of said person and said reference for said characteristic is a photograph of said person taken prior to said capturing.

86. A method as in claim 81, further comprising storing indicia identifying said worksite and a company employing said person in said data storage device, associating said indicia with said related data and transmitting said indicia with said related data from said data interface device through said communication network to said first computer.

87. A method as in claim 81, further comprising initiating said transmitting of said related data upon the storage capacity of said data storage device being reached.

88. A method as in claim 81, further comprising initiating said transmitting of said related data upon request of said computer.

89. A method as in claim 81, wherein said recording apparatus further comprises a display, and further comprising displaying on said display messages for said person and prompts for assisting said person in performing said entering.

90. A method as in claim 89, wherein said display comprises an LCD.

91. A method as in claim 81, wherein said data input device comprises a keypad.

92. A method as in claim 90, wherein said data input device comprises a touch-sensitive screen incorporated into said LCD.

93. A method as in claim 81, wherein said data input device comprises a wireless electronic communication device.

94. A method as in claim 81, wherein said data interface device comprises a wireless modem.

95. A method as in claim 83, wherein said geographical locating device comprises a global positioning system (GPS) receiver.

96. A method as in claim 83, wherein said geographical locating device comprises a cellular transmitter/receiver.

97. A method as in claim 89, wherein said first computer comprises a database and further comprising storing said messages in said database associated with said identity, transmitting said messages from said database through said communication network for storage in said data storage device and retrieving said messages from said data storage device for said displaying.

98. A method as in claim 82, wherein said communication network comprises the Internet, said first computer is associated with an application service provider on said Internet and said second computer is associated with a company employing said person.

99. A method as in claim 85, wherein said comparing comprises displaying on a display associated with said second computer said visual image next to said photograph to enable an operator of said second computer to perform a visual comparison of said visual image and said photograph.

100. A method for recording and verifying time and attendance data entered by employees at a worksite, comprising
providing at a worksite a portable time and attendance recording apparatus, said recording apparatus comprising a data storage device, a data input device, a clock, a biometric-capture device, a geographical locating device and a data interface device;
receiving on said recording apparatus attendance data entered by a person on said data input device indicating the identity of said person and that said person is clocking into or out of said worksite;
determining from said clock the time and date of said entering;
capturing from said biometric-capture device a biometric characteristic of said person;
determining from said geographical locating device the geographical location of said recording apparatus;
storing said attendance data, said time and date and said biometric characteristic in said storage device;
associating said attendance data, said time and date, said biometric characteristic and said geographical location with each other as related data;
transmitting said related data from said data interface device through a communication network to a first computer on said network remote from said geographical location.

101. A method as in claim 100, further comprising obtaining access to said first computer from a second computer on said network and verifying said related data, including said biometric characteristic and said geographical location, from said second computer.

102. A method as in claim 101, wherein said first computer contains a database storing a reference for said biometric characteristic and said verifying comprises comparing from said second computer said biometric characteristic with said reference.

103. A method as in claim 102, wherein biometric-capture device comprises a digital camera, said biometric characteristic is a visual image of said person and said reference for said biometric characteristic is a photograph of said person taken prior to said capturing.

104. A method as in claim 100, wherein said recording apparatus further comprises a display, and further comprising displaying on said display messages for said person and prompts for assisting said person in performing said entering.

105. A method as in claim 104, wherein said display comprises an LCD.

106. A method as in claim 100, wherein said data input device comprises a keypad.

107. A method as in claim 105, wherein said data input device comprises a touch-sensitive screen incorporated into said LCD.

108. A method as in claim 100, wherein said data input device comprises a wireless electronic communication device.

109. A method as in claim 100, wherein said data interface device comprises a wireless modem.

110. A method as in claim 100, wherein said geographical locating device comprises a global positioning system (GPS) receiver.

111. A method as in claim 100, wherein said geographical locating device comprises a cellular transmitter/receiver.

112. A method as in claim 104, wherein said first computer comprises a database and further comprising storing said messages in said database associated with said identity, transmitting said messages from said database through said communication network for storage in said data storage device and retrieving said messages from said data storage device for said displaying.

113. A method as in claim 101, wherein said communication network comprises the Internet, said first computer is associated with an application service provider on said Internet and said second computer is associated with a company employing said person.

114. A method as in claim 103, wherein said comparing comprises displaying on a display associated with said second computer said visual image next to said photograph to enable an operator of said second computer to perform a visual comparison of said visual image and said photograph.
